(19) United States
(12) Patent Application Publication
(10) Pub. No.: US 2012/0056441 A1
(43) Pub. Date: Mar. 8, 2012

(54) Sanitary Utensil Mounting System for Self-Serving Food Area

(76) Inventors: Blanca Estela Chavarria, Pasco, WA (US); Jesus J. Chavollo, Pasco, WA (US); Jose A. Chavallo, Kennewick, WA (US)

(21) Appl. No.: 13/296,052

(22) Filed: Nov. 14, 2011

Related U.S. Application Data
(63) Continuation-in-part of application No. 12/463,053, filed on May 8, 2009.

(51) Int. Cl. A47G 21/10; F16M 13/02; H01F 7/02; A47J 43/28

(52) U.S. Cl. 294/106; 30/327; 248/206.5

(57) ABSTRACT

An improved, sanitary utensil mounting system for a self-serving food area that has at least one overhanging, transparent protective panel that prevents respiratory and direct contact contamination of the food by customers. The system includes an anchor plate is at least one magnet that is magnetically attracted to an outside base located on the outside surface of the panel directly opposite the anchor plate. Attached the anchor plate is an elastic cord. Attached to the lower end of the cord is a dishwasher safe dual ring connector that selectively attaches to a slide lock hook formed on the distal end of the utensil's handle. The slide lock hook includes an upper portion that allows the utensil to slide freely over the dual ring connector. The slide lock hook includes a slot that narrows and is biased inward thereby causing the user to apply an upward force to the utensil force in order to remove the utensil from the dual ring connector

This is a continuation in part application based on pending U.S. patent application (Ser. No. 12/463,053) filed on May 5, 2009.

### BACKGROUND OF THE INVENTION

1. Field of the Invention

This invention relates to utensil mounting devices and more particularly to utensils mounted devices used in self-serving buffets or islands used in a restaurant.

2. Description of the Related Art

Many restaurants have self-service buffets counters, bars or islands where large containers of main dishes, side dishes, salads, appetizers or deserts are placed for customers of the restaurant to visit and serve themselves. Typically, the self-service buffets, counters, bars or islands are partially covered, elongated structures where various metal and glass containers containing hot or cold food items are placed. In the counters, bars and islands the quantity and the quality of the individual food items are constantly monitored by the restaurant workers.

Food preparation and food serving activities are closely regulated by local or state governments. In self service environments where individuals select various food items from a plurality of shared large containers, special precautions and regulations must be taken to keep the individual food items protected from excessive respiratory exposure and physical contamination from the consumers. Most local and state regulators require that restaurants install sneeze shields around the buffets to protect the food items from air borne contamination. In most restaurants, the sneeze shields are transparent panels made of glass or plastic material that enable the food area to be illuminated and enable the various food items to be easily seen from distance. The sneeze shield be easy to clean and must be devoid of surfaces and seams that can harbor bacteria

Many regulators require that each food item in the self-service counter, bar or island have their own serving utensils to prevent cross-contamination. Also, many regulators require that the utensils be replaced and all the surfaces and objects located in and around the serving area be cleaned at regular intervals (i.e. every two hours). To reduce contaminations, utensils that are dropped or mishandled must be immediately replaced by the restaurant workers. Many regulators require that secondary storage bins be provided for each set of serving utensils so that the serving utensils when not in use are not laid directly in the food. Such bins must also be replaced on at regular intervals (i.e. every eight hours). Furthermore, the serving utensils used at the buffet must be an adequate size and shape so that the handle may be easily grasped by the customer without contaminating the utensil's food contact area.

What is needed is a utensil mounting system that may be used with a self-serving counter, bar, or island that uses transparent walls, roofs or sneeze shields, which addresses the unique contamination and sanitary problems found in these areas.

### SUMMARY OF THE INVENTION

An improved utensil mounting system for use in a buffet style, self-serving food area that is partially covered by an elevated, transparent roof or sneeze shield (hereinafter called panels) designed to maintain the food items at a desired server temperature and to protect the food items from contamination. The utensil mounting system is specifically designed to address the well-known, unresolved problems created by these self-serving food areas.

The system includes a utensil with an elongated handle attached to the end of an elastic or retractable cord. The opposite end of the cord is connected to an anchor plate designed to be removably mounted at any location to the inside surface of an overhanging, transparent wall, roof panel or sneeze shield or strut located above food display area. In one embodiment of the invention, the anchor plate is used with a base located over the outside surface of the wall, panel or shield directly across from or to adjacent to the anchor plate. Located inside the anchor plate is at least one magnet that generates a magnetic force against a second magnet or a piece of magnetically attracted material located in the base to hold the anchor plate and base together on opposite sides of the wall, panel or shield.

Because the walls, roofs, and sneeze shields are typically planar, transparent structures made of non-magnetic attractive material, the anchor plate may be easily attached and detached from the inside surface of the panel. Because no screws, bolts, hooks, clips or tapes are required to mount the anchor plate, the device may be mounted at any location.

Also, because both the anchor plate and the outside base can be easily detached and removed, the surfaces on the wall, panel or shield around the food display area can be easily and frequently cleaned.

In one embodiment, the utensil is a plastic or stainless steel, spring-loaded tong, ladle, fork, or spatula with hole formed on the end of the handle that extends around a slotted eyelet or ring attached to the end of the elastic cord. In another embodiment of the utensil, the slotted eyelet or ring is replaced by a continuous dual ring member and the hole formed on the end of the handle is replaced by a slide look hook. The slide lock hook includes an upper passageway that enables the utensil to slide freely over the lower hold formed on the continuous dual ring member. The slide lock hook is configured so that the when the utensil is forced downward, the handle becomes coupled to the continuous ring member. To remove the utensil from the continuous ring member, the continuous ring member must be held and an upward force must be applied to the utensil to force the slide lock hook to disengage from the continuous ring member. Because the continuous dual ring member must be held and substantial upward force must be applied to the utensil, the utensil is less likely to disengage from the continuous dual ring member and fall into the food area.

The elastic cord includes a protective sheath or outer cover that enables it to be frequently cleaned. The elastic cord must have a resting length less and sufficient tensile strength when attached to the anchor base and to the utensil, to hold the utensil above the food item. When the utensil is used to serve a food item, the elastic cord should have a stretch length that enables it to be pulled downward to reach the food item and then serve the portion of food onto the customer's plate. The cord has a maximum stretched or extension length that prevents the utensil from contact surfaces outside of the food display area. The magnets used with the device must apply sufficient magnetic force so that the anchor plate is securely held in place on the wall, roof, or sneeze shield at all times during normal use.

In one embodiment, a device is distributed in a kit with a plurality of exchangeable cords having different lengths so that the utensil may be used with different cords used to reach different panels or attached to different locations on the same panel. The cords and utensils may also be color-coded to help the food worker identify the different cord lengths.

### DESCRIPTION OF THE DRAWINGS

FIG. 1 is a perspective view of a self-serving food area, shown as a salad bar, with transparent roof panels or sneeze shields with five improved serving devices magnetically held in position to the transparent panels or to a metal strut used therein.

FIG. 2 is a sectional side elevational view of the first embodiment of the improved serving device that uses two magnets located in the anchor plate and the outside base, respectively that are located on opposite sides of the transparent panel.

FIG. 3 is a sectional side elevational view of the second embodiment of the improved serving device that uses one large magnet located in the anchor plate and a magnetically attractive metal strip located on the bottom surface of the outside base.

FIG. 4 is a sectional side elevational view of the device shown to be attached to a strut made of metallic, magnetic attractive material.

FIG. 5 is a top plan view of the anchor plate partially cut away to show the relative position of the first magnet attached thereto.

FIG. 6 is a top plan view of the outside base partially cut away to show the relative position of the second magnet attached thereto.

FIG. 7 is a front elevational view of the device with a dual ring connector and an elongated handle with a slide hook formed on one end.

FIG. 8 is a side elevational view of the device shown in FIG. 7.

FIG. 9 is a front elevational view of a continuous dual ring connector used between the lower end of the elastic cord and the handle on a utensil.

FIG. 10 is a bottom plan view of the dual ring connector taken along line 10-10 in FIG. 9.

FIG. 11 is a perspective view of a ladle with a slide hook formed on the end of handle

FIG. 12 is a side elevational view of the ladle shown in FIG. 11 being forcibly moved upward to disengage from the dual ring connector.

FIG. 13 is a perspective view of a tong with an elongated handle with a slide hook formed on one end.

FIG. 14 is a side elevational view of the tong shown in FIG. 13 being forcible lifted on the dual ring connector to disengage the tong therefrom.

FIG. 15 is a front elevational view of the tong shown in FIGS. 12 and 13.

### DESCRIPTION OF THE PREFERRED EMBODIMENT(S)

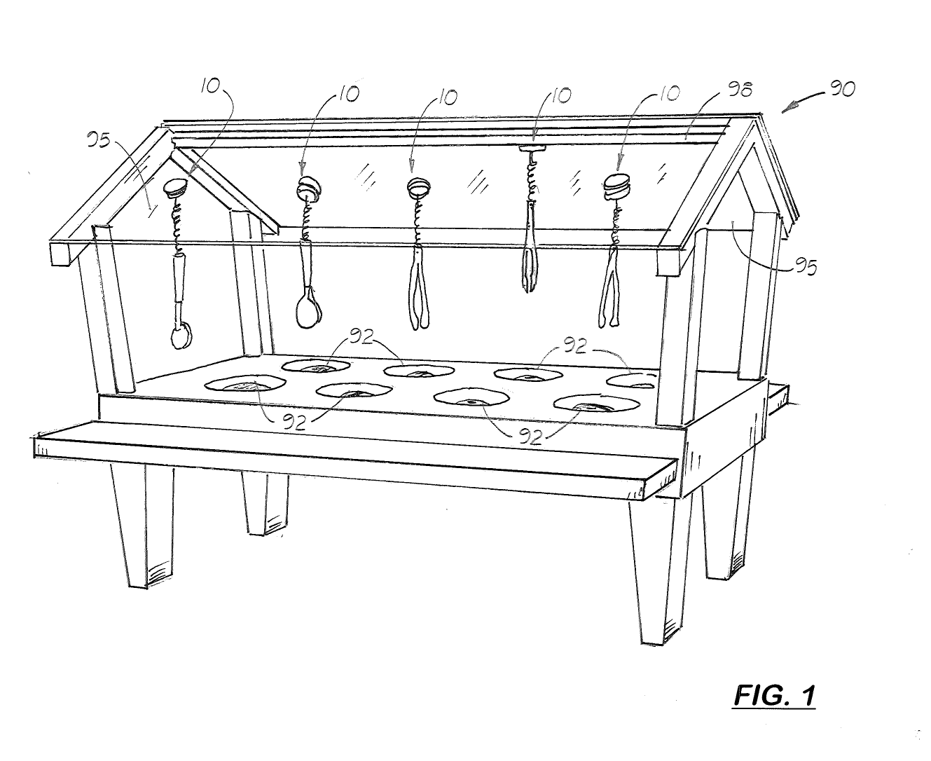

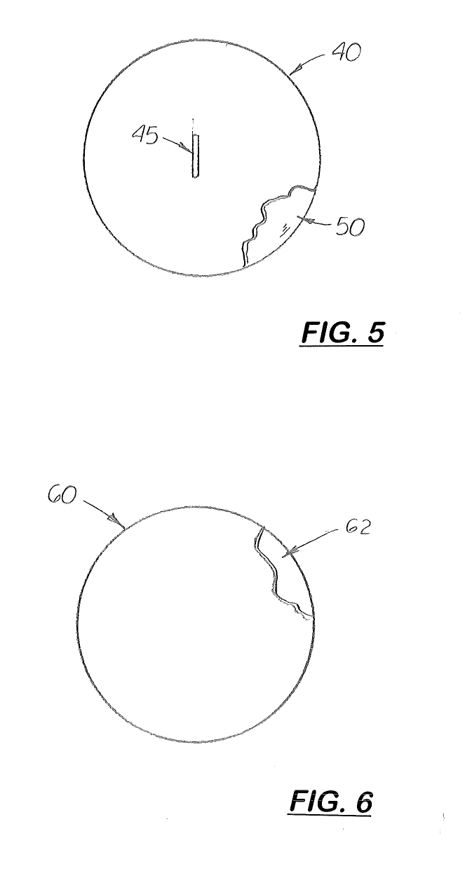

Referring to the FIGS. 1-6, there is shown an improved, sanitary serving device 10 and method used with a self-serving food display area 90 that has at least one overhanging, transparent protective panel 95 that prevents respiratory and direct contact contamination of the food items 92 in the food display area 90 by customers.

The device 10 includes a food utensil 20 with an elongated handle 25. Selectively attached to the end of the handle 25 is an elastic or length adjustable spiral rebounding coil 30. The cord 30 is approximately 10 inches long with two 90 degree fused loops attached to 1 inch split ring. The upper end of the cord 30 is selectively attached to an anchor plate 40 that is positioned on the inside surface of the transparent protective panel 95 that overhangs the food items 92. Located on the top surface of the anchor plate 40 is at least one magnet 50 (also called a first magnet 50) that is magnetically attracted to an outside base 60 that, during use, is located on the outside surface of the panel 95 directly opposite the anchor plate 40. In the first embodiment, a second magnet 62 is attached to the bottom surface of the outside base 60 that is magnetically attracted to the first magnet 50. Both magnets 50, 62 must have sufficient magnet flux so that the anchor plate 60 is securely held in a temporary fixed position on the panel 95 as the utensil 20 is used to serve food items 92.

In the preferred embodiment, the cord 30 includes a protective cover or outer sheath 32 that covers an elastic member 34 located therein. The outer sheath 32 which is made of vinyl other suitable material capable of being washed with warm soap and water that protects the elastic member 34. Formed on the upper end of the cord 30 is a closed loop 38 that selectively engages a hook 45 formed or attached to the anchor plate 40. The cord 30 must have a resting length less (approximately 6 to 12 inches) and sufficient tensile strength so that when the cord 30 when attached to the anchor base 40 and to a utensil 20, the lower tip of the utensil 20 is held above the food item 92. The cord 30 must be able to stretch a sufficient distance so that utensil 20 may be used to serve the food item 92 but remain in the serving area.

The utensil 20 may be any style utensil with an elongated handle used to serve food. Examples may be a spring-loaded tong 21, a ladle 21′, or a fork 21″. In the first embodiment, a split ring 27 is attached or formed on the end of the elongated handle. Formed on the end of the cord 30 is closed loop 22 that attaches to a small ring 29 that selectively attaches handle thereby enabling the utensil 20 to be selectively attached and detached.

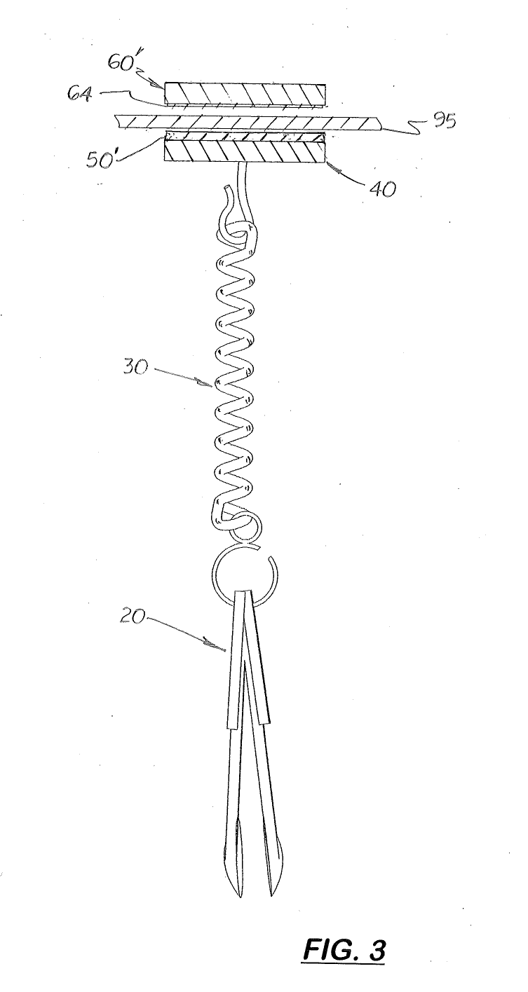

In a second embodiment of the invention shown in FIG. 3, the first magnet 50 is replaced by a stronger first magnet 50′ (shown for illustration purposes only as a thicker structure) and the second magnet 62 on the outside plate 60 is replaced by a thin flat plate 64 made of magnetically attractive material (i.e. stainless steel) that holds the anchor plate 40 in place on the panel 95.

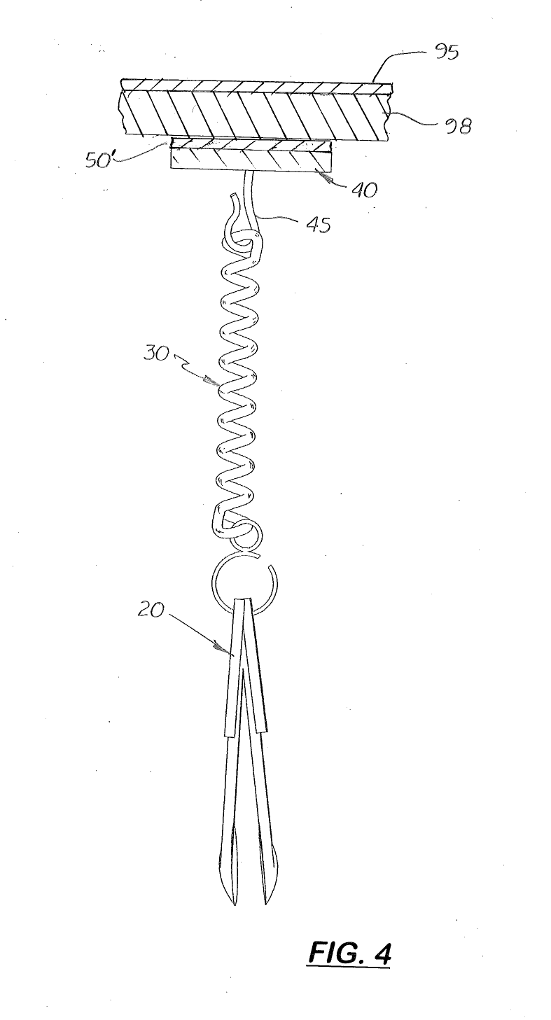

In a third embodiment of the invention shown in FIG. 4, the first magnet 50 is also replaced by a stronger first magnet 50′ with the anchor plate 40 being magnetically connected to the strut 98 made of magnetically attractive material (i.e. stainless steel) that holds the anchor plate 40 in place on the strut 98.

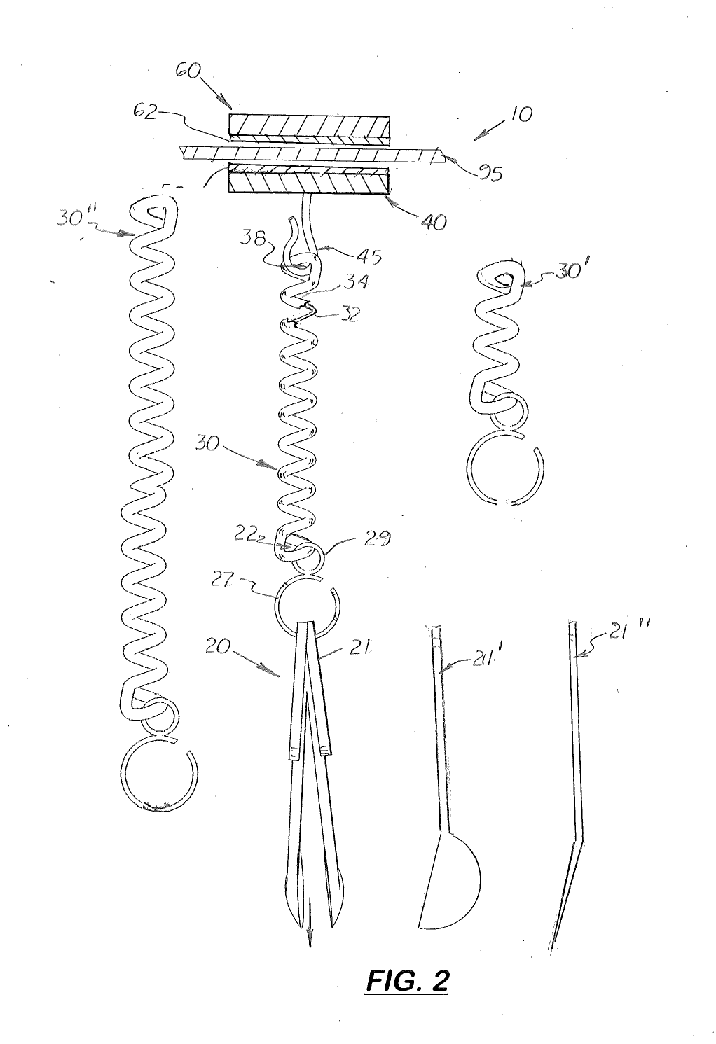

During use, a desired utensil (shown in FIG. 2 as tong 20, ladle 20′, and fork 20″) needed to serve the food item 92 is first identified. The desired area on the transparent panel 95 located above the food item 92 is identified for attaching the anchor plate 40. The distance from the identified attaching point on the panel 95 or strut 98 to the area where the food item 92 is served is then determined. An elastic cord 30 must have a suitable stretch or extension length that matches the needed distance to reach the food item and holds the utensil (tong 20, ladle 20′, or fork 20″) in a resting position above the food item 95 is then selected. The elastic cord 30 is then attached to the anchor plate 40 and the anchor plate 40 is then positioned over the attaching point. When the anchor plate 40 is attached to a panel 90, the outside base 60 is then positioned on the outside surface of the panel 90 directly over the attaching point and anchor plate 40 to hold the anchor plate 40 in place on the panel 90. A desired utensil is then attached to the lower end of the elastic cord 30 and is ready for use.

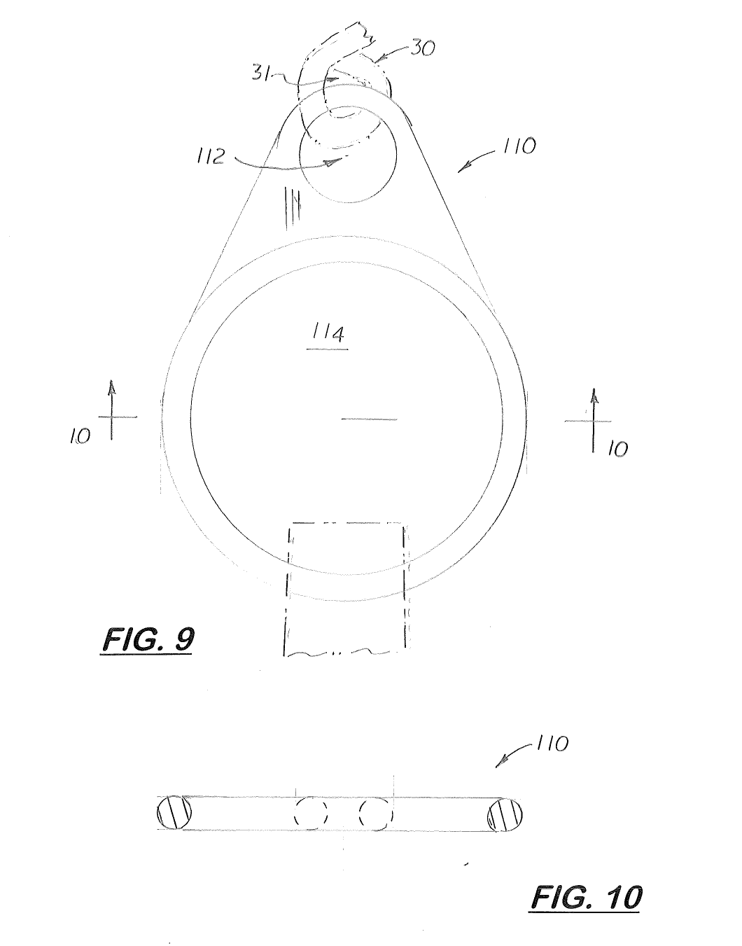

In another embodiment of the invention, the split ring 27 and small ring 29 are replaced by a flat, metal or plastic dual ring connector 110 with a continuous small upper hole 112 and a continuous large lower hole 114 shown in FIGS. 9 and 10. Formed on the lower end of the elastic cord 30 is a loop 31 that extends around the upper hole 112 to securely attach the ring connector 110 to the elastic cord 30.

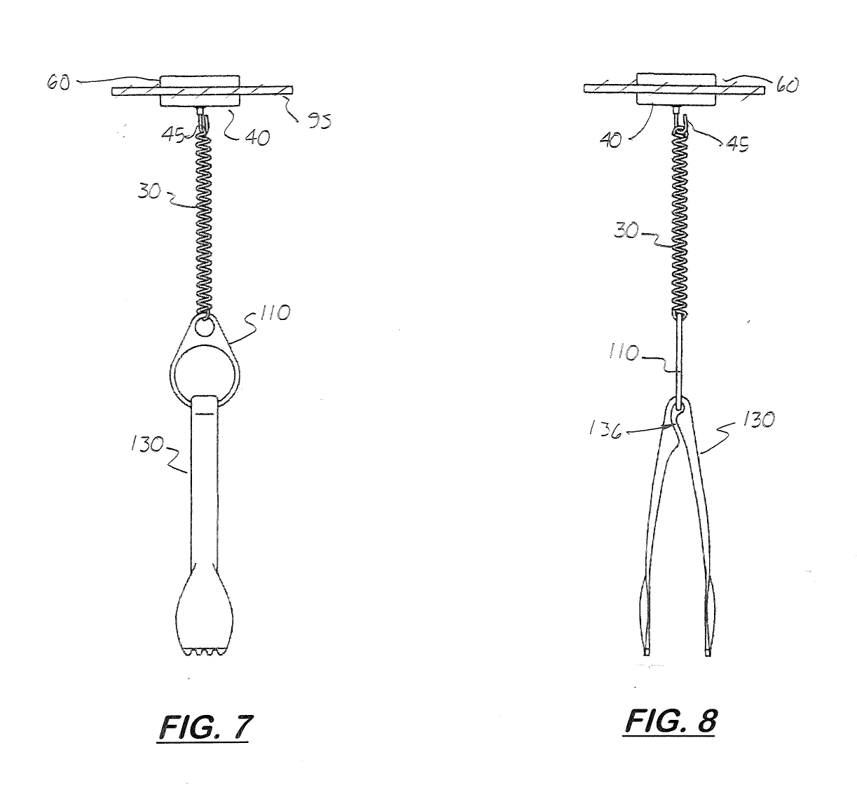

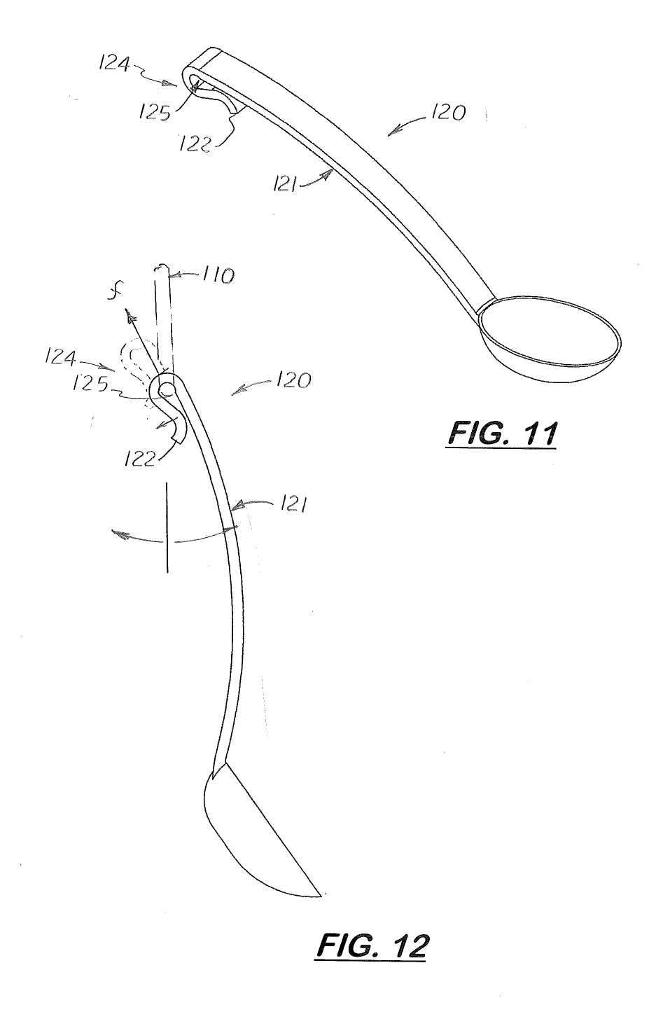

FIGS. 7, 8, 11-12 and FIGS. 13-15 show two alternative utensils 120, 130 each with slide lock hooks 124, 134, respectively, formed on the upper ends of their elongated handles 121, 131, respectively. Each slide lock hook 124, 134 has a wide upper portion 125, 135, respectively, that enables the utensil to slide freely around the curved segment on the lower hole 114 formed on the dual ring connector 110. In FIGS. 9 and 10, a ladle utensil 120 is shown in which the tip 122 of the handle 121 is curved backward against the back surface of the handle 121 forming an inverted tear drop-shaped slide lock hook 124. Formed on the upper portion of the slide lock hook 124 is a narrow passageway 125 designed to slide freely over the ring connector 110. When attaching the utensil 120 to the dual ring connector 110, the tip 122 of the handle 121 is forced through the narrow passageway 125 and the arms are forced outward as the curved segment on the lower hole 114 on the dual ring connector 110.

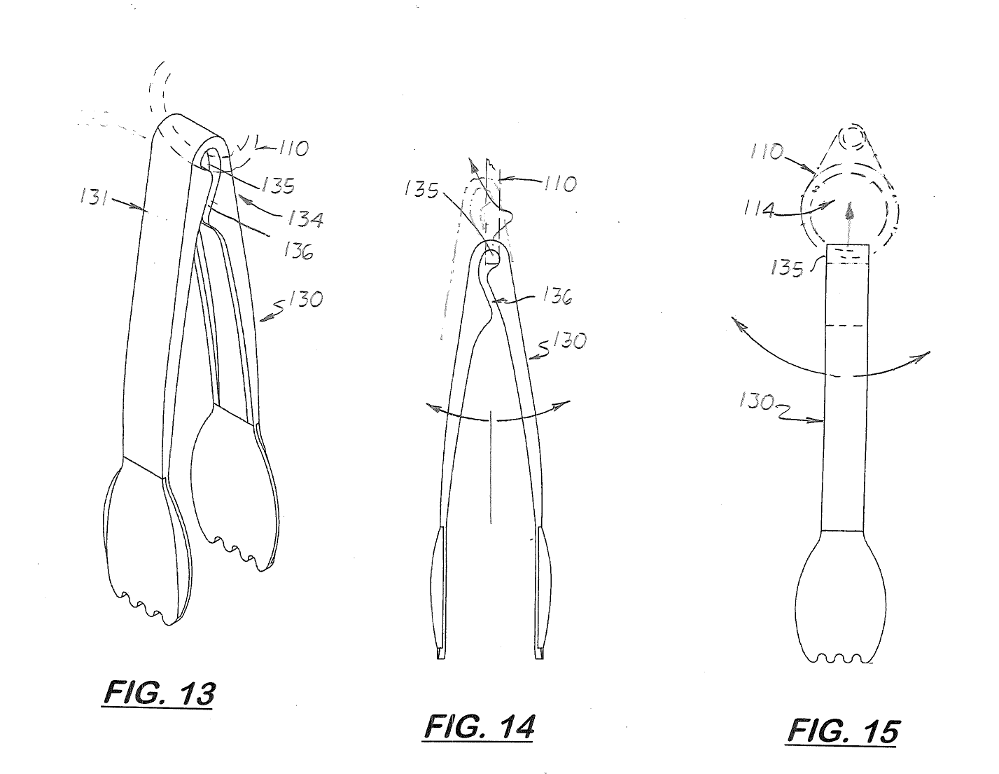

In FIGS. 13-15, the utensil 130 is a tong with a curved slide lock hook 134 formed on the end of the handle 131. The slide lock hook 134 includes an upper wide bore 135 and a lower curved narrow slot 136 that is smaller in width than the upper wide bore 135. When a curve segment on the dual ring connector 110 is forced through the narrow passageway 136, the hook's two arms are separated thereby enabling the curved segment on the dual ring connector 110 to slide through the narrow passageway 136 thereby enabling the slide lock hook 134 to engage the dual ring connector 110.

During use, the dual ring connector 110 must be held and the utensils 120, 130 are lifted to force the curve segment on the dual ring connector 110 through the slide lock hooks 124, 134, respectively, thereby reducing the chance of the utensils from accidentally disengaging from the elastic cord 30.

During use, the restaurant worker determines the best location to place the anchor plate 40. During use, the magnetic forces between the magnet 50 on the anchor plate 40 and the outside base 60 force or the strut 98 hold the anchor plate 40 in place The anchor plate 40 can be forcibly pulled from the panel 95 or strut 98 for easy cleaning or then repositioned for different food items 92. Because no secondary clips or brackets are required to attach the anchor plate 40, the panel 95, or the strut 98, or the anchor plate 50 may be easily removed for cleaning and the panel 92 and strut 98 may be easily cleaned. Once the anchor plate 40 has been attached, the elastic cord 30 is then attached to the anchor plate 40. The desired utensil is then attached to the end of the elastic cord 30.

In compliance with the statute, the invention described herein has been described in language more or less specific as to structural features. It should be understood, however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

We claim:

1. An improved, sanitary serving device used with a self-serving food area with at least one overhanging, transparent protective panel, said device comprising:
a. an anchor plate located on an inside surface of said protective panel;
b. an outside base located on an outside surface of said protective panel opposite said anchor plate;
c. at least one magnet disposed between said anchor plate and said outside base, said magnet used to selectively force said anchor plate and said outside base together on opposite sides of a protective panel;
d. an elastic cord that includes a first end and a second end, said second end being selectively attached to said anchor plate;
e. a dual ring connector attached to said first end of said elastic cord; and,
f. a food utensil with an elongated handle, said elongated handle includes an distal end with a slide lock hook formed thereon that receives and slides over the edge on said dual ring connector.

2. The sanitary serving device as recited in claim 1, wherein said utensil is a ladle with an upper tip bent reward over said handle to create a tear-shaped slot.

3. The serving device, as recited in claim 1, wherein said dual ring connector is made of dishwasher safe material.

4. The sanitary serving device as recited in claim 1, wherein said utensil is a tong with a curve slot form therein.

5. The serving device, as recited in claim 4, wherein said dual ring connector is made of dishwasher safe material.
